(19) United States
(12) Patent Application Publication
(10) Pub. No.: US 2005/0177318 A1
(43) Pub. Date: Aug. 11, 2005

(54) Methods, systems and computer program products for identifying pharmacophores in molecules using inferred conformations and inferred feature importance

(75) Inventors: Sidney Stanley Young, Raleigh, NC (US); Jun Feng, Carrboro, NC (US); Ashish Prabhakar Sanil, Monmouth Junction, NJ (US)

Correspondence Address: MYERS BIGEL SIBLEY & SAJOVEC, PO BOX 37428, RALEIGH, NC, 27627, US

(73) Assignee: National Institute of Statistical Sciences

(21) Appl. No.: 11/050,563

(22) Filed: Feb. 3, 2005

Related U.S. Application Data
(60) Provisional application No. 60/543,314, filed on Feb. 10, 2004.

(51) Int. Cl. G06F 19/00

(52) U.S. Cl. 702/27

(57) ABSTRACT

Pharmacophores in molecules may be identified by generating a set of conformations for a respective molecule. A respective conformation includes a series of features that are present or absent in the conformation, wherein a respective feature includes at least two molecular elements and at least one distance between the molecular elements. The features for a set of conformations for a given molecule are repeatedly compared to a model of feature importance of remaining molecules, to identify an inferred conformation of a given molecule, until the model of feature importance for the molecules converges.

### RELATED APPLICATION

This application claims the benefit of provisional Application No. 60/543,314, filed Feb. 10, 2004, entitled Pharmacophore Mapping, the disclosure of which is hereby incorporated herein by reference in its entirety as if set forth fully herein.

### FIELD OF THE INVENTION

This invention relates to computational chemistry methods, systems and computer program products, and more particularly to methods, systems and computer program products for identifying pharmacophores in molecules.

### BACKGROUND OF THE INVENTION

The discovery of new chemically active and/or bioactive molecules has become increasingly important, for example in drug discovery. Unfortunately, however, the binding of a molecule into a protein generally is inherently a three-dimensional event. Moreover, only about one third of the current drug targets presently have a crystal structure of the target protein to guide drug design efforts. Accordingly, it is desirable to provide computational methods that can use biological assayed potency data and/or other empirical data to identify one or more pharmacophores, i.e., an arrangement of key binding features in space. It may also be desirable to know a binding conformation and the key features that allow a molecule to bind to a protein. As used herein, a “conformation” means any of the spatial arrangements of a molecule that can be obtained by rotation of the atoms about a single bond, and a “feature” means two or more molecular elements and the related distances therebetween. Once a pharmacophore is identified computationally, it can be used to guide selection of compounds to screen, virtual screening, and/or to guide lead optimization efforts, the modification of existing molecules and/or the design of new molecules.

In view of the above, considerable effort has been expended to infer pharmacophore features using only biological potency of molecules along with their crystal structures. Pharmacophore identification methods, systems and computer program products are described, for example, in Martin, “Pharmacophore Mapping”, Chapter 6 in Designing Bioactive Molecules: Three Dimensional Techniques and Applications, American Chemical Society, Washington, D.C., 1998; Güner, Ed., Pharmacophore, Perception, Development, and Use in Drug Design, International University Line. La Jolla, Calif., 1999; Kurogi et al., Current Medicinal Chemistry, 9, pp. 1035-1055, 2001; Patel et al., J Comput Aided Mol Des., 16, pp. 653-681, 2002; and Güiner et al., Current Medicinal Chemistry, 11, pp. 2991-3005, 2004. Pharmacophore identification is also described in U.S. Pat. No. 6,421,612 to Agrafiotis et al., entitled System, Method and Computer Program Product for Identifying Chemical Compounds Having Desired Properties, and published U.S. patent application Ser. No. 2004/0236555 A1 to Pierce et al., entitled Target Ligand Generation. See also, U.S. Pat. No. 6,434,542 to Farmen et al., entitled Statistical Deconvoluting of Mixtures, and U.S. Published patent application Ser. No. 2003/0061186 to Farmen et al., entitled Statistical Deconvoluting of Mixtures.

### SUMMARY OF THE INVENTION

Pharmacophores in a plurality of molecules may be identified, according to various embodiments of the present invention, by generating a set of conformations for a respective molecule. A respective conformation comprises a series of features that are present or absent in the conformation, wherein a respective feature comprises at least two molecular elements and at least one distance therebetween. The features for a set of conformations for a given molecule are repeatedly compared to a model of feature importance of remaining molecules, to identify an inferred conformation for the given molecule and update the model of feature importance, until the model of feature importance for the plurality of molecules converges. In some embodiments, the repeated comparing of the features for a set of conformations for the given molecule to a model of feature importance of the remaining molecules is performed using Gibbs sampling, expectation maximization, stochastic sampling and/or other techniques.

In some embodiments, the repeated comparing of the features for a set of conformations for the given molecule to a model of feature importance of the remaining molecules, to identify an inferred conformation for the given molecule, until the model of feature importance for the plurality of molecules converges may be performed by selecting an initial inferred conformation for a respective molecule from the set of conformations for the respective molecule, to generate an initial set of inferred conformations for the plurality of molecules. Then, for a given molecule, features that are present in the inferred conformations for the remaining molecules are identified to obtain an initial model of feature importance. The set of conformations for the given molecule is then compared to the initial model of feature importance to identify an updated inferred conformation for the given molecule. Then, the initial inferred conformation for the first molecule is replaced with the updated inferred conformation for the first molecule. The above operations are then repeated for the remaining molecules, to obtain an updated model of feature importance and a set of updated inferred conformations for the plurality of molecules. The above operations are repeatedly performed until the updated model of feature importance for the plurality of molecules converges, to thereby obtain a final model of feature importance.

In some embodiments of the present invention, the identifying of features that are present in the inferred conformations for the remaining molecules to obtain an initial model of feature importance is performed by identifying features that are present in the inferred conformations for the remaining molecules to obtain a model of feature prevalence. Then, the model of feature prevalence is compared with a model of historical prevalence for the features to obtain the model of feature importance. Finally, the conformations for the given molecule are compared with the model of feature importance to obtain a model of conformation likelihood for the respective conformations of a given molecule.

In still other embodiments of the present invention, the model of feature importance is repeatedly mapped onto the respective inferred conformations, to obtain one or more pharmacophore hypothesis sets of features for a respective conformation. Inferred conformations that are consistent with the respective hypothesis sets of features are identified. One or more of the pharmacophore hypothesis sets is then selected based upon a measure of conformations that are consistent with a respective pharmacophore hypothesis sets. In some embodiments, repeated mapping of the model of feature importance onto the respective inferred conformations is performed by identifying one or more completely connected graphs that are consistent with the respective hypothesis sets of features that were inferred. The one or more completely connected graphs may be identified by executing a clique finding algorithm, such as a Bron-Kerbosch algorithm. Accordingly, some embodiments of the present invention can identify two or more pharmacophores that are consistent with the inferred conformations that have converged.

Moreover, the identification of multiple pharmacophores in a given data set according to embodiments of the present invention may be used independent of the particular method that is used to identify pharmacophores. In particular, some embodiments of the present invention can generate a set of conformations for a respective molecule, wherein a respective conformation includes a series of features that are present or absent in the conformation, and a respective feature includes two or more molecular elements and one or more distances therebetween. Two or more pharmacophores are then identified that are consistent with the set of conformations. If there are two pharmacophores, then the identified conformations of one set of molecules may give rise to one pharmacophore and the identified conformations of another set of molecules may give rise to the second pharmacophore. The two or more pharmacophores may be identified by identifying two or more completely connected graphs that are consistent with the set of conformations for each set of molecules. The connected graphs may be identified by executing a clique finding algorithm, such as Bron-Kerbosch.

Still other embodiments of the present invention can compare the set of conformations for the given molecule to the initial model of feature importance to identify an inferred conformation for the given molecule by comparing, using regression techniques, the set of conformations for the given molecule to the initial model of feature importance, taking into account relative potency data for the plurality of molecules, to identify an updated inferred conformation for the given molecule. Comparing using regression can be performed using multiple linear regression, partial least squares, ridge regression, neural network, logistic regression and/or support vector machine techniques.

Moreover, this comparing using regression may be used to identify pharmacophores in a plurality of molecules from a set of conformations for a respective module, by comparing the set of conformations with the respective molecules to a model of feature importance, taking into account relative potency data for the plurality of molecules, to identify inferred conformations for the plurality of molecules. Accordingly, relative potency data may be taken into account in identifying pharmacophores, using regression.

It will be understood that embodiments of the invention have been described above primarily with respect to methods of identifying pharmacophores. However, analogous systems and computer program products also may be provided.

### BRIEF DESCRIPTION OF THE DRAWINGS

FIG. 1 is a block diagram of pharmacophore identifying methods, systems and/or computer program products according to embodiments of the present invention.

FIG. 2 schematically illustrates a data structure that may be used with embodiments of the present invention.

FIGS. 3-8 are flowcharts of operations that may be performed for pharmacophore identification according to various embodiments of the present invention.

FIG. 9 graphically illustrates how, for each pair of molecular elements and binned distance, a bit is set or not depending on the presence or absence of the combination, for each conformation for a molecule. New conformations are added to the list until no new features are identified.

FIG. 10 illustrates a data structure according to some embodiments of the invention, wherein a feature is a triple of two molecular elements and the binned distance between them. The presence or absence of a feature is coded into 1/0. The features are written as a bit string for a respective conformation. A respective element of Q measures the importance of a respective feature. A respective element of P measures the prevalence of a respective feature in selected conformations. A respective element of H measures the prevalence of a respective feature in unselected conformations or in conformation in a historical data set. Q and P are used with the molecular conformation to determine the likelihood that a conformation is the binding conformation. The selected conformations (hypothesis), and P are used to determine the importance of the features, Q.

FIG. 11 illustrates a “toy” data set that was constructed with 20 conformations, bit strings, for each of 20 molecules. Four of the 20 features were the pharmacophore and one conformation for each molecule contained a 1 for those features. Embodiments of the invention can find the correct conformations and features for the toy data set. The selected conformations are shown for eight molecules.

FIG. 12 graphically illustrates 21 superimposed D4 ligands that were selected by embodiments of the invention. Basic pharmacophore points include two aromatic centers and a positive charge center.

FIG. 13 graphically illustrates pharmacophore No. 1 that was identified by embodiments of the invention, with 65 of 78 ACE molecules superimposed. There are three pharmacophore features in common to the molecules and they include two negative charged centers and hydrogen bond acceptor. The 65 conformations were selected from the 46,268 conformations; a 0.5 Å RMSD threshold for selecting conformations.

FIG. 14 graphically illustrates how embodiments of the invention also determine pharmacophore No. 2, with 57 ACE molecules superimposed. Three pharmacophore features are in common to these molecules: two negative charged centers and one aromatic center.

FIG. 15 graphically illustrates “D2” Members: cpd08, cpd09, cpd10, cpd02, cpd03, cpd04. Distance ranges (Å): ACC˜POC: 5.45˜6.45; ACC˜POC: 6.69˜8.90; ACC˜ACC: 4.94˜5.04.

FIG. 16 graphically illustrates “D4” Members: cpd12, cpd13, cpd21, cpd15, cpd19, cpd18. Distance ranges (Å): ACC˜POC: 5.49˜6.08; ACC˜POC: 6.29˜7.24; ACC˜ACC: 11.78˜12.69.

### DETAILED DESCRIPTION

The present invention now will be described more fully hereinafter with reference to the accompanying drawings, in which illustrative embodiments of the invention are shown. However, this invention may be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “coupled”, “connected” or “responsive” to another element, it can be directly coupled, connected or responsive to the other element or intervening elements may also be present. In contrast, when an element is referred to as being “directly coupled”, “directly connected” or “directly responsive” to another element, there are no intervening elements present. Like numbers refer to like elements throughout. As used herein the term “and/or” includes any and all combinations of one or more of the associated listed items and may be abbreviated by “/”.

It will also be understood that, although the terms first, second, etc. may be used herein to describe various elements, these elements should not be limited by these terms. These terms are only used to distinguish one element from another element.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art in light of the present disclosure, and will not be interpreted in an idealized or overly formal sense unless expressly so defined herein.

The present invention is described in part below with reference to block diagrams and flowcharts of methods, systems and computer program products according to embodiments of the invention. It will be understood that a block of the block diagrams or flowcharts, and combinations of blocks in the block diagrams or flowcharts, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. A computer program according to embodiments of the invention comprises a computer usable storage medium having computer-readable program code embodied therein. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems (structural and/or means-plus-function).

It should also be noted that in some alternate implementations, the functions/acts noted in the flowcharts may occur out of the order noted in the flowcharts. For example, two blocks shown in succession may in fact be executed substantially concurrently or the blocks may sometimes be executed in the reverse order, depending upon the functionality/acts involved. Finally, the functionality of one or more blocks may be separated and/or combined with that of other blocks.

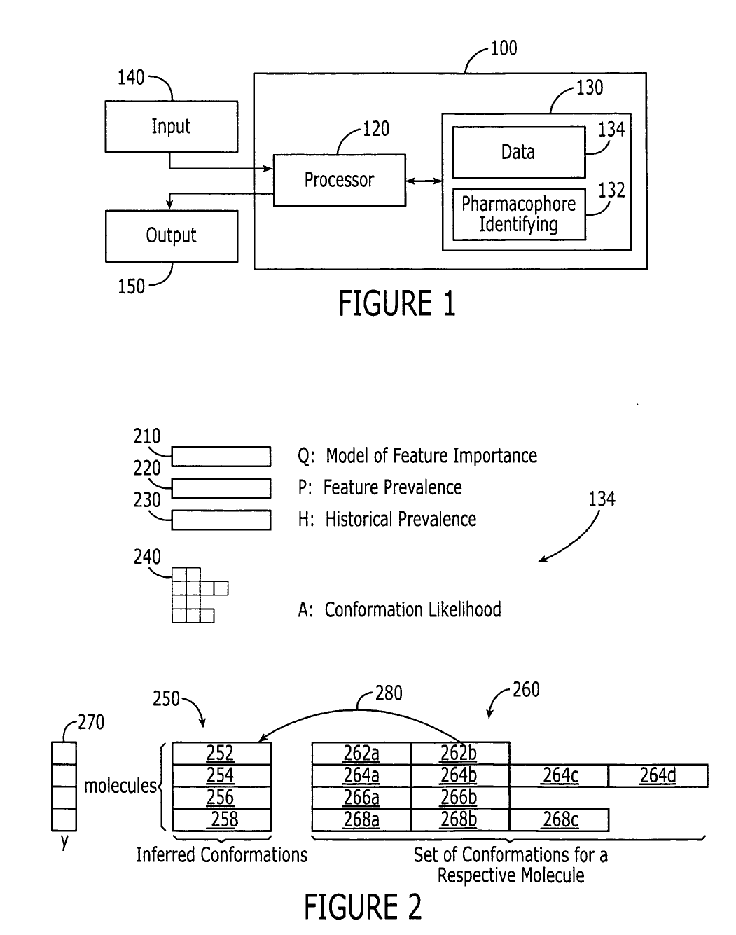

FIG. 1 is a block diagram of pharmacophore identifying methods, systems and/or computer program products according to various embodiments of the present invention. As shown in FIG. 1, these pharmacophore identifying methods, systems and/or computer program products include a processing system, method and/or computer program product 100 that includes a processor 120 and a memory 130 that communicates with the processor 120. The processor 120 may be embodied as one or more enterprise, application, personal, pervasive and/or embedded computer systems and/or special purpose hardware that may be connected by a wired and/or wireless network. The memory 130 may represent an overall hierarchy of memory devices containing software and/or data including, but not limited to, the following types of memory devices: cache, ROM, PROM, EPROM, EEPROM, flash memory, SRAM, DRAM, removable and/or fixed media, as well as virtual storage. One or more input devices 140, such as a keyboard or keypad and/or a storage device, may be used to provide input data to the processor 120. One or more output devices 150, such as a display and/or storage device, may be used to display or store output data that is produced by the processor 120.

As also shown in FIG. 1, the memory 130 includes one or more pharmacophore identifying modules 132 and one or more data structures 134 that may be used by the pharmacophore identifying module(s) 132. Other software, such as an operating system, also may be included. It will further be appreciated that functionality of the pharmacophore identifying module(s) 132 may be embodied, at least in part, using discrete hardware components, one or more Application Specific Integrated Circuits (ASIC) and/or a special purpose digital processor.

FIG. 2 schematically illustrates a data structure, such as a data structure 134 of FIG. 1, that may be used in identifying pharmacophores according to various embodiments of the present invention. As shown in FIG. 2, this data structure includes a set of conformations 260 for a plurality of molecules. In FIG. 2, a given molecule is represented by a row of the set of conformations 260, so that FIG. 2 illustrates a set of conformations 260 for four molecules. For a given molecule, the number of columns indicates the number of conformations that are generated. Thus, in FIG. 2, the first molecule has two conformations 262a-262b, the second molecule has four conformations 264a-264d, the third molecule has two conformations, and the fourth molecule has three conformations 268a-268c. It will be understood by those having skill in the art, however, that in real world embodiments, many more than four molecules and many more than up to four conformations per molecule may be present.

Continuing with the description of FIG. 2, the data structure 134 also includes a set of inferred conformations 250. As will be described in detail below, for any given molecule, one of the conformations from the set of conformations 260 is selected as an inferred conformation 250. Thus, FIG. 2 illustrates four inferred conformations 252-258.

The data structure 134 of FIG. 2 also includes a model of feature importance 210, also referred to as Q. A respective element of Q measures the importance of a respective feature in the corresponding inferred conformations 250. The data structure 134 also includes a model of feature prevalence 220, also designated as P. A respective element of P measures the prevalence of a respective feature in selected conformations. The historical database may be included in H, a model of historical prevalence 230. As will be described below, P and H are used to determine Q. Q with the molecular conformations is used to determine the likelihood that a conformation is the binding conformation. These likelihoods are stored in a conformation likelihood data structure 240, also referred to as A. A respective element of A measures a respective likelihood that a respective conformation 262a-268c is a binding conformation.

The data structure 134 of FIG. 2 also includes a model of relative potency data 270, also referred to y, for the plurality of molecules. This model of potency data 270 may be used in identifying pharmacophores, as will be described in detail below.

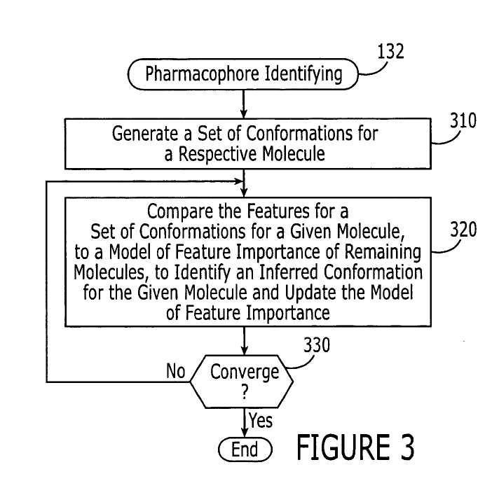

FIG. 3 is a flowchart of operations that may be performed to identify pharmacophores according to various embodiments of the present invention. These operations may be performed by a pharmacophore identifying module 132 of FIG. 1.

Referring to FIG. 3, at Block 310, a set of conformations is generated for a respective molecule. A respective conformation includes a series of features that are present or absent in the conformation, wherein a respective feature comprises at least two molecular elements and at least one distance therebetween. In the examples used herein, a respective feature consists of only two molecular elements and a single distance therebetween. However, higher order features that include more than two molecular elements and more than one distance between the elements also may be used in various embodiments of the present invention. The set of conformations may correspond to the set of conformations 260 of FIG. 2.

Still referring to FIG. 3, at Block 320, the features for a set of conformations for a given molecule, such as the set of two conformations 262a, 262b for the first molecule (row) in the set of conformations 260 in FIG. 2, is compared to a model of feature importance Q (210) of the remaining molecules, such as the second, third and fourth molecules, to identify an inferred conformation 250 for the given molecule, such as the inferred conformation 252 for first molecule and to update the model of feature importance Q (210). The operations of Block 320 are repeatedly performed at Block 330 until the model of feature importance Q for the plurality of molecules converges. As described in more detail below, operations of Block 320 may be performed, for example, using Gibbs sampling, expectation maximization and/or stochastic sampling.

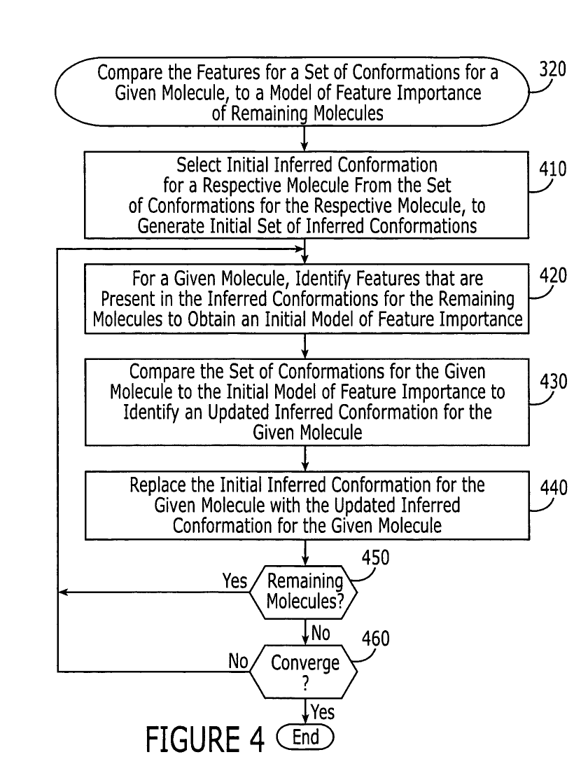

FIG. 4 is a flowchart of operations that may be performed to repeatedly compare the features for a set of conformations for a given molecule, to a model of feature importance of remaining molecules, to identify an inferred conformation for the given molecule, corresponding to Block 320 of FIG. 3. In particular, referring to FIG. 4, at Block 410, an initial inferred conformation 250 for a respective molecule, such as inferred conformation molecule 252, is selected from the set of conformations 260 for the respective molecule, such as conformations 262a or 264b, to generate an initial set of inferred conformations 250. At Block 420, for a given molecule, such as the first molecule, features are identified that are present in the inferred conformations for the remaining molecules 254-258, to obtain an initial model of feature importance 210. Then, at Block 430, the set of conformations for the given molecule, such as a set of conformations 262a, 262b is compared to the initial model of feature importance 210, to identify an updated inferred conformation 252 for the given molecule as shown by arrow 280. Thus, one of the set of conformations 262a, 262b for the given molecule is moved to the set of inferred conformations 250 to provide the inferred conformation 252 for the given molecule. In other embodiments of the operations of Block 430, the set of conformations for the given molecule is compared, using regression, to the initial model of feature importance, taking into account relative potency data 270, also referred to as y, for the plurality of molecules, to identify an updated inferred conformation for the given molecule. Regression may be performed, for example, using multiple linear regression, partial least squares, ridge regression, neural network, logistic regression and/or support vector machine techniques.

Continuing with the description of FIG. 4, at Block 440, the initial inferred conformation for the given molecule is replaced with the updated inferred conformation for the given molecule, to provide the inferred conformation 252 for the given molecule. Then, at Block 450, the operations of Blocks 420, 430 and 440, are repeated for the remaining molecules, such as the second, third and fourth molecules, and these operations are repeatedly performed until, at Block 460, the updated model of feature importance Q for the plurality of molecules converges, to thereby obtain a final model of feature importance Q.

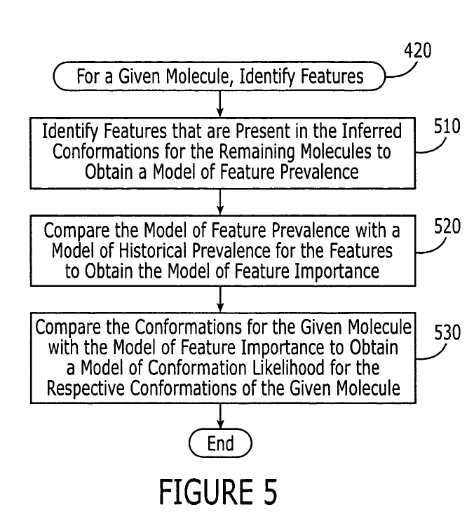

FIG. 5 is a flowchart of operations that may be performed for a given molecule to identify the features that are present in the inferred conformations for the remaining molecules to obtain the initial model of feature importance, corresponding to Block 420 of FIG. 4. As shown at Block 510, features that are present in the inferred conformations for the remaining molecules, such as the inferred conformations 254, 256 and 258 of FIG. 2 are identified to obtain a model of feature prevalence P (220). At Block 520, the model of feature prevalence P (220) is compared with a model of historical prevalence for the features H (230), to obtain the model of feature importance Q, (210). Then at Block 530, the conformations for the given molecule, for example, the conformations 262a, 262b, are compared with the model of feature importance Q, to obtain a model of conformation likelihood A (240) for the respective conformations of a given molecule.

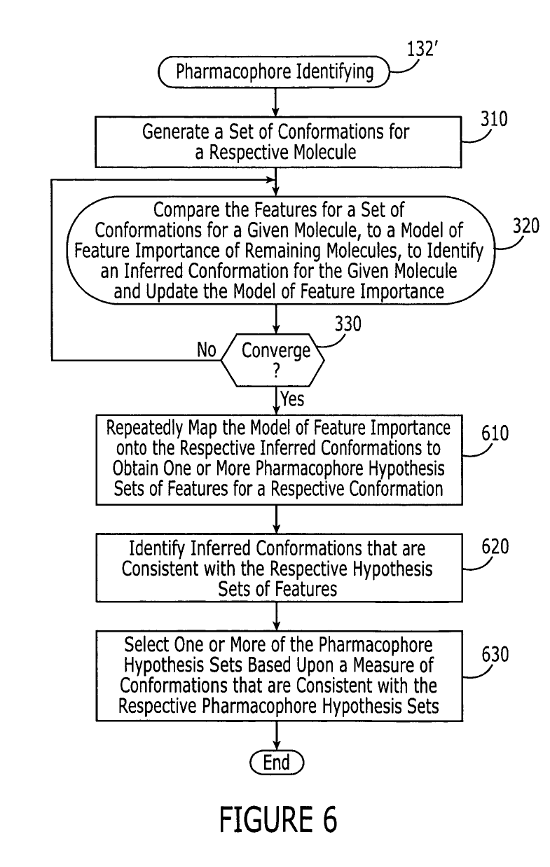

FIG. 6 is a flowchart of operations for identifying pharmacophores 132′ according to other embodiments of the present invention. In particular, in these embodiments, the operations of Blocks 310, 320 and 330 are performed to obtain a model of feature importance Q (210), and a set of inferred conformations 250. Operations of Block 610-630, described below, may then be used to generate one or more pharmacophore hypothesis sets. Thus, according to some embodiments of the invention, more than one pharmacophore hypothesis set may be generated.

In particular, at Block 610, the model of feature importance Q (210) is repeatedly mapped onto the respective inferred conformations (and hence molecules) 250, to obtain one or more pharmacophore hypothesis sets of features for a respective conformation in the set. At Block 620, inferred conformations 250 that are consistent with the respective hypothesis sets of features are identified. Finally, at Block 630, one or more of the pharmacophore hypothesis sets is selected based upon a measure of conformations (and hence molecules) that are consistent with the respective pharmacophore hypothesis sets.

Still referring to FIG. 6, the mapping of Block 610 may be performed by identifying one or more completely connected graphs that are consistent with the respective hypothesis sets of features that were inferred. As is well known to those having skill in the art, a completely connected graph is a consistent graph that identifies rigid connections between the vertices thereof. In a completely connected graph, no vertex can move without violation of a distance between vertices. Some of the features identified as a result of Block 330, when mapped onto a conformation, may not be part of a completely connected graph. Among the identified features, however, subsets can be rigid. These are identified and each completely connected graph becomes a hypothesis. The completely connected graphs may be identified by executing a clique finding algorithm. Clique finding algorithms are well known to those having skill in the art, and need not be described herein. One well known example of a clique finding algorithm is a Bron-Kerbosch algorithm that will be described in detail below. Accordingly, embodiments of FIG. 6 can identify two or more pharmacophores that are consistent with the inferred conformations that have converged.

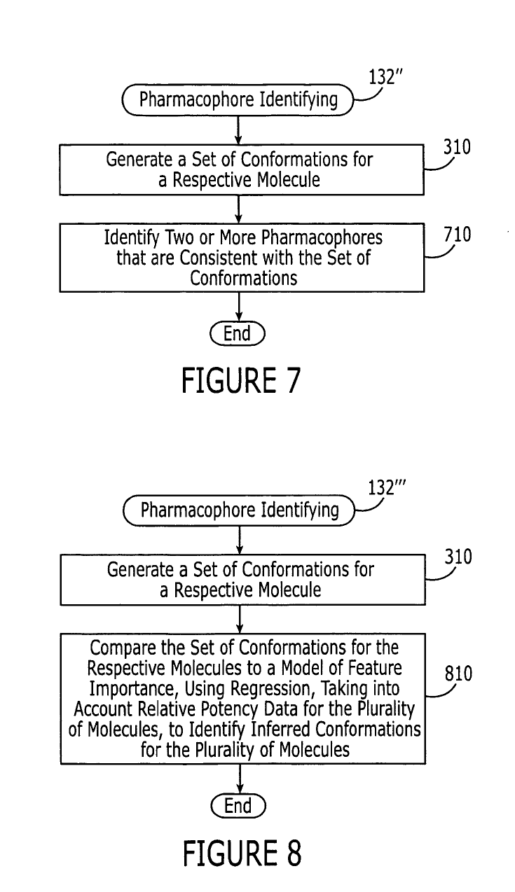

FIG. 7 is a block diagram of pharmacophore identifying methods 132″ according to other embodiments of the present invention. In these embodiments, a set of conformations is generated for a respective molecule, corresponding to Block 310. Then, at Block 710, two or more pharmacophores that are consistent with the set of conformations is identified. Most typically one set of conformations, representative of a subset of the molecules, will be consistent with one pharmacophore while another set of conformations will be consistent with another set of molecules. Conventionally, pharmacophore identifying techniques desire to identify a single most probable pharmacophore. Yet, in real world analysis, often two or more pharmacophores may generate a desired activity. Embodiments of the present invention can identify two or more pharmacophores that are consistent with the set of conformations. For example, operations that were described above in connection with FIG. 6 that can identify completely connected graphs, using clique finding algorithms such as Bron-Kerbosch, may be used to identify two or more pharmacophores that are consistent with the set of conformations.

FIG. 8 is a flowchart of operations that may be performed to identify pharmacophores 132′″ according to still other embodiments of the invention. As shown in FIG. 8, a set of conformations for a respective molecule is generated as was described in Block 310. Then, at Block 810, the set of conformations for the respective molecules is compared, using regression, to the model of feature importance Q, taking into account relative potency data y (270) for the plurality of molecules, to identify inferred conformations for the plurality of molecules. As was described in connection with Block 430 of FIG. 4, this regression comparison may be performed using, for example, multiple linear regression, partial least squares, ridge regression, neural network, logistic regression and/or support vector machine techniques. Conventionally, pharmacophore identification may not take into account the relative potency data for the plurality of molecules, choosing to work only with active compounds. However, embodiments of the invention that are described in FIG. 8 can use a regression comparison to take into account the relative potency data.

Additional discussion of various embodiments of the invention that were described above in connection with FIGS. 1-8, as well as a mathematical framework therefor, now will be provided.

In particular, small molecules typically have rotatable bonds and often have flexible rings so they can take any of a vast number of shapes. Each shape will put atoms into different relative positions in space. It is desirable to know the binding conformation for each molecule. If there are multiple binding modes or binding sites, it is also desirable to know which molecules may be put together as they are binding in the same way. It is also desirable to identify the key features that interact with the target protein or, if the assay system contains multiple targets, the molecules that bind to each target. Both the determination of the binding conformation and its key features can have extremely large search spaces. For example, a molecule with five rotatable bonds and three flexible six member rings might be represented with 3⁵2³=1944 distinct conformations. Much effort has been expended in selecting features to represent the biologically important characteristics of a molecule, as described, for example, in Leach et al., An Introduction to Chemoinformatics, Kluwer Academic Publishers, Dordrecht, 2003.

One technique of feature representation is to create a bit string where each bit gives the presence or absence, for example 1/0, of a feature in the conformation of the molecule. There are a number of features that medicinal chemists have considered important. A molecular feature can include two atoms or molecule fragments and the through-space distance between them. Typical features include the following: hydrogen bond donor, hydrogen bond acceptor, positively charged group, negatively charged group, lipophilic group, aromatic ring center, halogen, etc. The distance is often given in a range, e.g. three to five Ångstroms. Thus, a feature might be HBD 3-5 HBA. The features and the distance bins of 2-4, 4-8, 8-12, 12 or more, may give rise to 105 pharmacophore-pair/distance features. Using these features, each conformation of a molecule can be represented as a bit string of 105 bits. A richer list of features, more distance bins, or extensions to three, four or five features can vastly increase the number of bits in the string used to represent a conformation.

Some embodiments of the invention can use a modification of Gibbs sampling (described, for example, in Lawrence et al., Science, 262, pp. 208-214, 1993, and Rouchka, sapiens.wustl.edu/˜ecr/PAPERS/gibbs.pdf, 1997) whereby the most likely binding conformations and the key binding features are identified for each molecule. In some embodiments, these results are used with a clique detection method such as Bron-Kerbosch (as described, for example, in Bron, Comm ACM, 16, pp. 575-577, 1973), find a rigid set of features and with fixed distances between them.

Some embodiments of the present invention may provide four general analysis operations: feature definition, pharmacophore fingerprint alignment, hypothesis generation and refinement. Feature definition was described generally above at Block 310. Pharmacophore fingerprint alignment was described generally in Block 320, and more specifically in FIGS. 4 and 5. Hypothesis generation was described generally at Block 610, and refinement was described generally at Blocks 620-630. Additional details now will be provided, along with a mathematical foundation and additional illustrations.

1. Feature Definition

In some embodiments, six pharmacophore features are predefined: hydrogen bond donor, hydrogen bond acceptor, aromatic ring center, hydrophobic center, negative charge center, and positive charge center. Certain features can be defined as a vector, which means the angle between direction or normal vectors satisfies a predefined threshold.

In some embodiments, the well known Daylight SMART language is used to define pharmacophore features. Users can change the rules based on their understanding of the problem. For certain datasets, like ACE inhibitors, this may be desirable for pharmacophore identification since there are some uncommon definitions for pharmacophore features, like zinc binding site, in the ACE dataset.

The distance between each pair or pairs of features is computed. The distances are placed into bins. In some embodiments, the default bins are 2-4, 4-8, 8-12, 12 or larger Ångstroms. The user can change the definitions of the bins, add more bins, overlap bins, etc. During pharmacophore generation stage, the selected conformations for all molecules may be superimposed, and the actual distance ranges may be calculated if the superimposition satisfies a user provided Root Mean Square Distance (RMSD) cutoff. The features and the observed distances between them may be used to define the final pharmacophore.

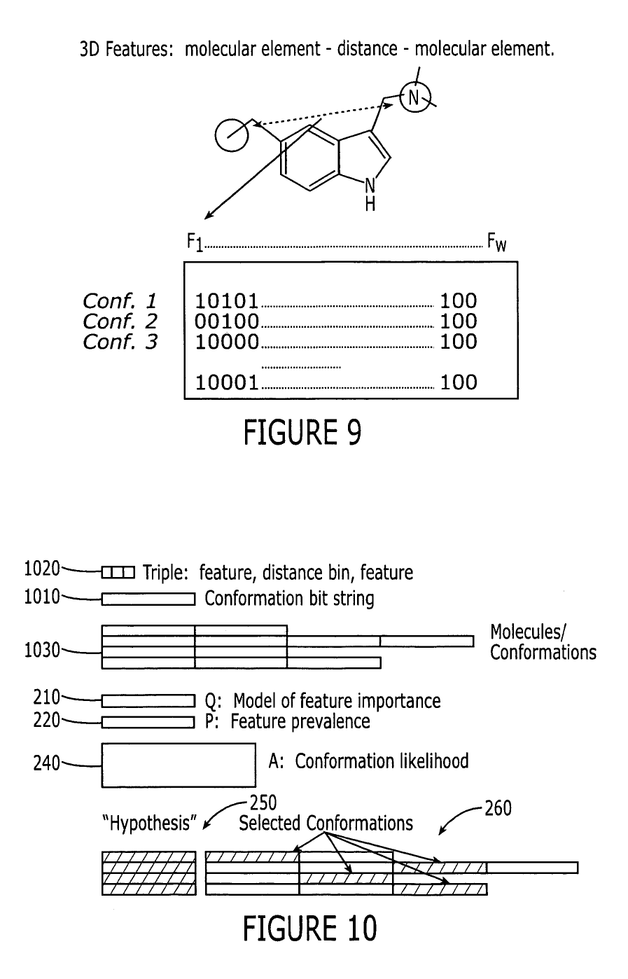

A feature pair is defined as two pharmacophore features and the distance (binned) between them. If a conformation has the pair, a certain bit is set to one. If a conformation does not have the pair, that bit is set to zero. A bit string is used to represent each conformation. As shown in FIG. 9, W feature pairs give rise to a bit string that is W bits wide. In some embodiments, more than two features also could be considered, e.g. feature triples.

2. Pharmacophore Fingerprints Alignment

FIG. 10 schematically illustrates another data structure that may be used according to other embodiments of the invention.
a. Consider N active molecules. In some embodiments, the width of each conformation bit string 1010 is W. Each bit of a conformation bit string is '1' or '0', which indicates whether a specific pharmacophore feature pair 1020 is presented or not.
b. The conformation bit strings 1010 are placed end to end to make a composite, molecule bit string 1030 that has mᵢ×W elements where mᵢ is the number of conformations for molecule i.
c. For each position k between 1 to W on the bit string, the possibility vector Q (210), with elements (q_{k,0},q_{k,1}), denotes the probabilities of '0' and '1' on position k (As q_{k,0} and q_{k,1} sum to 1, only one element need be stored). c_{k,0}, and c_{k,1} denote the occurrence of '0' and '1' on position k for a currently selected binding conformation (P, the feature prevalence vector). Again, as the number of molecules is fixed at N, only one c need be tracked for each position. The background frequency for '1' and '0' are p₁ and p₀, respectively, (p₁+p₀)=1. These background frequencies can be computed from some collection of drugs or drug-like compounds. They may be taken as constants over all the features and/or computed specifically for each feature, p₁ₖ and p₀ₖ. The alignment vectors (A₁, A₂, A₃, . . . A_{N}) denote the likelihood of each conformation is to be chosen for each molecule to form the alignment conformation set. Collectively the Aᵢ form A, the conformation likelihood matrix 240. The elements of the probability vector Q can be calculated by occurrence vector c and number of molecules N:

$${q}_{i , j} = \frac{{c}_{i , j} + {b}_{j}}{N - 1 + B} , \qquad ( Eq . 1 )$$

where i=1,2, . . . W;j=0,1;bⱼ and B are called pseudo-counts, and

$$B = {\sum }_{i = 0}^{1} {b}_{j} = \sqrt{N} ; {b}_{j} = {ρ}_{j} B ,$$

where pⱼ is the frequency of feature j (0 or 1) in the whole or a reference dataset. The pseudo-counts are quantities that capture baseline 'prior information'in the underlying Bayesian statistical model. The above form for bⱼ and B is considered to be a reasonable way to quantify this prior information. See, Lawrence et al., Science, 262, pp. 208-214, 1993, and Rouchka, sapiens.wustl.edu/˜ecr/PAPERS/gibbs.pdf, 1997, for details. More than capturing additional information, the pseudo-counts can provide a convenient, effective and meaningful device for dealing with the awkward cases of ckⱼ being 0 (which would lead to q_{k,j}=0 without the pseudo-count correction). The reference data set could be the data set under consideration in the analysis or it could be some historical data set. However, the pseudo-count values may be set using other techniques. For example, the values could be based on a scientist's expert opinion of what would best reflect the prior knowledge for the particular set of molecules, or based on historical evidence or other similar data sets. In these embodiments, there may be no y[270]. Q, thus, may be essentially the “Model” by which conformations are evaluated to compute A. When y [270] is present, the model may take a different form, which may depend on the regression method. For example, for multiple linear regression yᵢ=ΣaⱼFⱼ+eᵢ, where the Fⱼ are the 0/1 variables denoting the features and the aⱼ are determined from the multiple linear regression analysis. The sizes of the eᵢ are used to compute A, the likelihood of the conformations. Since these statistical predictive models (such as multiple linear regression, PLS, etc.) are based on probability models for the data, the errors too may follow a corresponding probability model. This probability distribution of the errors (associated with the particular technique) may be used as a basis for identifying the “goodness-of-fit” of the points. Typical numerical criteria for assessing goodness-of-fit may be chosen to be proportional to the probability density or likelihood function. Conventional variants that often possess desirable properties include using the logarithm of the likelihood function, and ratios of log-likelihoods.
d. Start with a random alignment matrix A, and select one conformation bit string per compound according to the alignment matrix A.
e. Remove the bit string of one compound, z, from the alignment (Block 410).
f. Use the remaining compounds to update probability vector Q using Eq. 1 (Block 420).
g. Calculate Qₓ(x=1,2, . . . M_{z}) (Block 510), which is the probability of generating every bit string for the removed molecule using current probability pattern q_{i,j}, and Pₓ, which is the probability of generating every bit string for the removed molecule using background probability pattern pⱼ (Block 520). The weight for each conformation bit string Aₓ=Qₓ/Pₓ. is used to sample one conformation bit string for the removed compound (Block 530). The conformation bit strings with higher weights (Aₓ) will have higher chance to be picked (Block 430).
h. Repeat the steps from c to g for all compounds (Block 450) over and over again until the scoring function

$$F = {\sum }_{i = 1}^{W} {\sum }_{j = 0}^{1} {c}_{i , j} log \frac{{q}_{i , j}}{{p}_{j}}$$

is converged (Block 460). Other scoring functions may be used.
i. To speed up the whole procedure, in g the conformation bit string with the highest weight (Aₓ) may be used instead of randomly sampling based upon likelihood. This may quickly converge to a local minimum, so different starting alignment vectors may be used.

A general framework that encompasses many embodiments of pharmacophore fingerprint alignment now will be provided. An abstract formulation of the pharmacophore identification problem is as follows. From a set of conformations of several compounds, find:
1. A set of conformations (250), one per compound, that is most likely to be a binding conformation of the particular compound (denote this set as C), and
2. A vector of probabilities (240), denoted by P=(p₁, p₂, . . . pₘ) where m is the number of 0/1-features being used in the representation of a conformation, and each pⱼ is the probability that the j^{th} feature is present in the true (but unknown) binding conformation.

An appropriate objective function F(P,C) is formulated that provides a numerical evaluation of how good a particular choice of P and C is, and then the values of P and C are found that can maximize this function. Finding the optimal values of P and C may be difficult since the P-C space of potential solutions may be prohibitively large for systematic exploration. Embodiments of the invention can reduce the size of the solution-space by proceeding iteratively, alternating between P and C. For example, fix the current value of P and then select an appropriate C in light of the current P, then fix the C and select another P, and so on. A selection scheme is devised that can lead to optimal (or at least good) solutions for P and C if the iterative process is carried out long enough. Selection schemes according to some embodiments of the invention can fall into at least three broad categories:
A. Greedy Maximization: These embodiments of the invention can use a greedy hill-climbing method. The iteration proceeds as follows: fix the current value of P and then select the best C in light of the current P, then fix the C and select the best P for the current value of C, and so on. In the case where P and C are modeled as random quantities (i.e., assigned probability distributions) and the optimal (P,C) sought is the pair that is the most likely values of P and C, then the F-function corresponds to the “likelihood function” and embodiments of the invention can use an “Expectation-Maximization” (EM) algorithm. This scheme can be the simplest of the three described herein, and may use the least computational effort. However, it may be prone to the well-known potential limitations of hill-climbing methods (e.g., it might lead to a local maximum of F rather than the global one).
B. Stochastic Sampling: In these embodiments, P and C are modeled as random quantities (i.e., assigned probability distributions). The probability distributions may be chosen/designed such that the “good” values of (P,C) occur with high probability, i.e., the probability likelihood function serves as the objective function F(P,C). A goal can be to draw random samples from the probability distribution. If it is a true sample from the distribution, then it ought to contain a large number of “good” (P,C) values. Thus, by examining the sample and processing it appropriately, estimates of the optimal P and C can be obtained. The distribution of (P,C) is high-dimensional and typically extremely complex, and drawing random samples from it may be very difficult in realistic models. Markov Chain Monte Carlo (MCMC) methods may be used. In some embodiments, a particular MCMC method is used known as “Gibbs sampling”. This scheme may be the most complex, and may be computationally very demanding. However, it can provide much more stable and richer solutions (e.g., error estimates can be obtained).
C. Hybrid Schemes: These embodiments can seek to find a good balance between the above two schemes in order to obtain better solutions as in (B) but at lower computational effort as in (A). For example, in some embodiments, the iterations can proceed as follows: fix the current value of P and then sample a value of C from the probability distribution of C given the current P, then fix the C and select the best P for the current value of C, and so on. These embodiments may provide the most promising and practical embodiments.

Some embodiments of the invention may provide a composite of all the three schemes described above with a hybrid scheme forming the dominant component. Greedy maximization may be used to find good starting points and approximate solutions. In some cases where there is clear signal in the data, this scheme may be adequate by itself. Pure stochastic sampling may be applied in cases when the solutions found using a combination of the other two schemes appear unsatisfactory. It may also be used in more complex situations—such as when multiple binding modes might be involved.

In addition to selecting the scheme or combination of schemes, an implemented embodiment may also involve the selection of:
1. The objective function F(P,C).
2. The probability distribution for the (P,C)-values. (This may not always be needed in some pure hill-climbing schemes.) The specification of probability distributions might also entail the specification the value(s) of one or more parameters of the distribution (Bayesian statisticians refer to this as specifying the prior parameters).
3. A set of decision-rules for taking the output from the algorithm and producing scientifically useful estimates of the features of binding conformations. (This may not be straightforward when the output might be a sample from a probability distribution.)

Reference implementations to demonstrate embodiments of the invention and to study their effectiveness may include two computer programs—one is a pure greedy maximization approach, and the other uses a hybrid strategy. Both programs can use the probability models presented in the above-cited Lawrence, et al. publication. The objective function F corresponds to the “likelihood function”. Lawrence, et al. devised a hybrid scheme for the problem of genomic sequence-alignment. Their problem involved probability models and some algorithmic issues that may be adapted to binding conformation problems according to embodiments of the invention (which has a different data structure). They also proposed a greedy maximization version of the algorithm which can be used in embodiments of the invention. Lawrence et al. referred to their algorithm as a predictive Gibbs sampler and used the term “Gibbs sampling” as notational shorthand for the algorithm.

3. Hypothesis Generation

Fingerprint alignment picks out one conformation for each compound and a series significant pharmacophore features, in the case feature pairs (i.e., two point pharmacophores). However, whether these conformations can be combined to have common 3 points, 4 points or even higher order pharmacophores also may be determined according to some embodiments of the present invention.
a. All selected conformations are reexamined (Block 610). A clique detection algorithm (described, for example, in the above-cited Bron publication) is used to find all possible high order pharmacophores that contain the features selected during feature definition. To be a consistent pharmacophore, the selected points have to be supported by the features and distances selected during feature definition. Two points have one supported distance, three points have three supported distances, four points have 6 supported distances, etc.
b. All pharmacophore hypotheses are saved into a list.
c. There may be some molecules that do not participate any pharmacophores due to picking the wrong conformation in the alignment stage, or the molecule may be binding in an alternative binding mode or in an alternative binding site. In the refinement stage, embodiments of the invention can search all conformations of each molecule that is not mapped to a pharmacophore to attempt to fit it into a pharmacophore hypothesis until it satisfies a hypothesis or all conformations are exhausted.
   4. Refinement

After the hypothesis generation (Block 610), a list of pharmacophore hypotheses is created. Every hypothesis can be evaluated in the refinement stage.
a. Each hypothesis is evaluated to determine how many molecules can fit to it (Block 620). If the current conformation cannot fit to this hypothesis, the program will discard the current conformation and pick another conformation, test it again until it finds one conformation can fit to this hypothesis or until all conformations are discarded.
b. The refinement stage may find several hypotheses each satisfied by different compounds (Block 630). If several hypotheses are found, that suggests multiple mechanisms.

### EXAMPLES

The following examples shall be regarded as merely illustrative and shall not be construed as limiting the invention. Several examples will be used to describe embodiments of the invention. First, a toy example of synthetically constructed bit strings will be given. Next, it will be shown how embodiments of the invention can find the binding conformation and some of the key features for a small set of D2 ligands. Embodiments of the invention then are used to examine a large data set of ACE inhibitors. Two pharmacophores are found that utilize 65 and 57 molecules from the set of 78 ACE inhibitors. Finally, selected D2 and D4 active compounds (described, for example, in Bostrom et al., J Chem. Inf Comput. Sci., 43, pp. 1020-1027, 2003) are used to mimic a situation where there are two distinct binding modes or sites. All conformations were computed using Omega from OpenEye Scientific Software (as described, for example, in Omega, eyesopen.com/products/applications/omega.html).

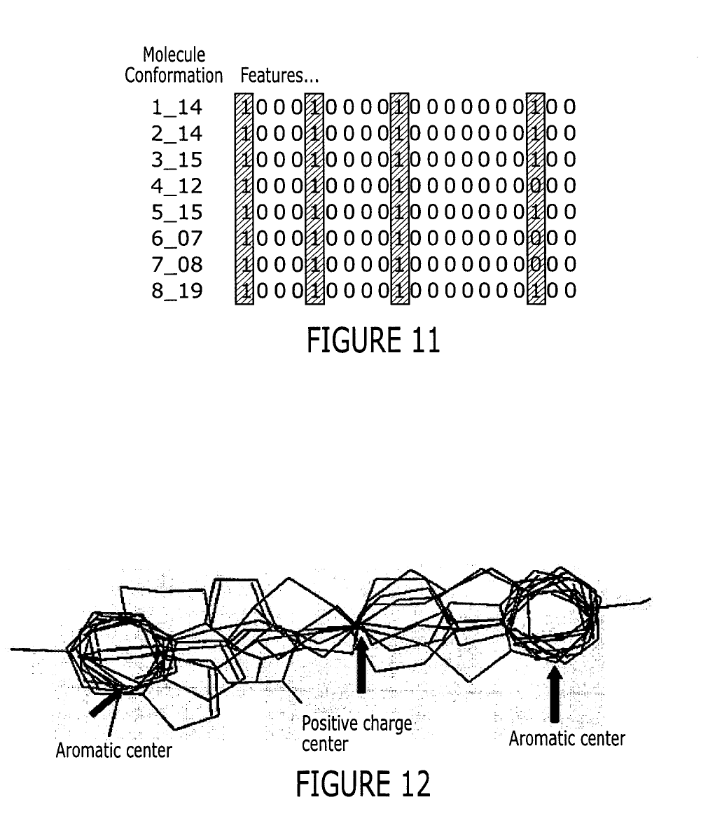

Example 0. To demonstrate that embodiments of the invention can successfully identify pharmacophoric features a toy data set of 0's and 1's was build. There are 20 molecules, each with 20 features and 20 conformations. The incidence of 1's was set low, ˜5%, to mimic the sparse nature of bit string representations of conformations. A conformation for each molecule was selected at random and bits were set to 1 for positions 1, 5, 10, and 18. So each “molecule” has one “binding” conformation with four features. Embodiments of the invention successfully found the binding conformation for each molecule. FIG. 11 displays the selected conformation for eight of the molecules. All the active conformations were found. Thus, embodiments of the invention can find conformations that have a consistent set of bits set.

Example 1. A 3D study of D2 and D4 ligands was undertaken by Böstrom et al. (as described in the above-cited Böstrom publication). They report a 3D pharmacophore. Twenty one (21) of the more active D2 compounds were processed according to embodiments of the invention and reproduced their results. See FIG. 12 where several of the overlaid conformations are displayed. This data set was chosen as it is considered an easy data set to solve, as noted in Van Drie, Chapter 27. Güner, O. F. Ed., Pharmacophore, Perception, Development, and Use in Drug Design, International University Line, La Jolla, Calif., 1999.

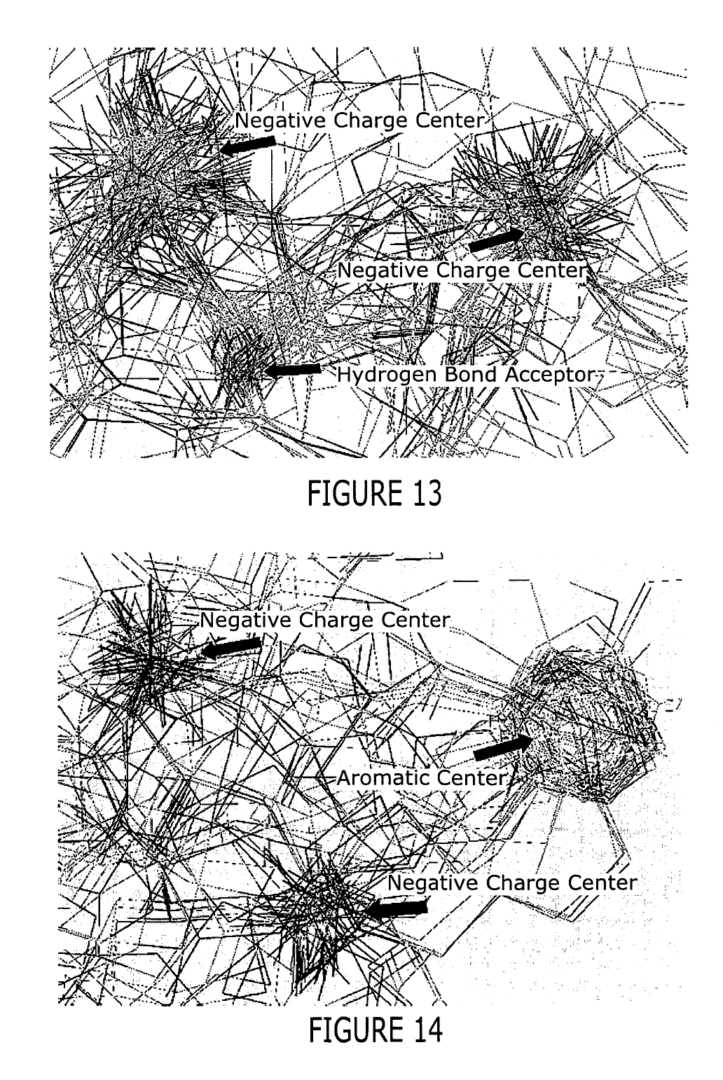

Example 2. A total of 78 ACE inhibitors taken from DePriest et al., J. Am. Chem. Soc. 115, pp. 5312-5384, 1993, with a total of over 46,000 conformations, were processed according to embodiments of the invention. Sixty-five of the compounds satisfied the pharmacophore shown in FIG. 13; the hydrogens are not shown for clarity. Fifty-seven of the molecules satisfied the conformation shown in FIG. 14; again, the hydrogens are not shown for clarity.

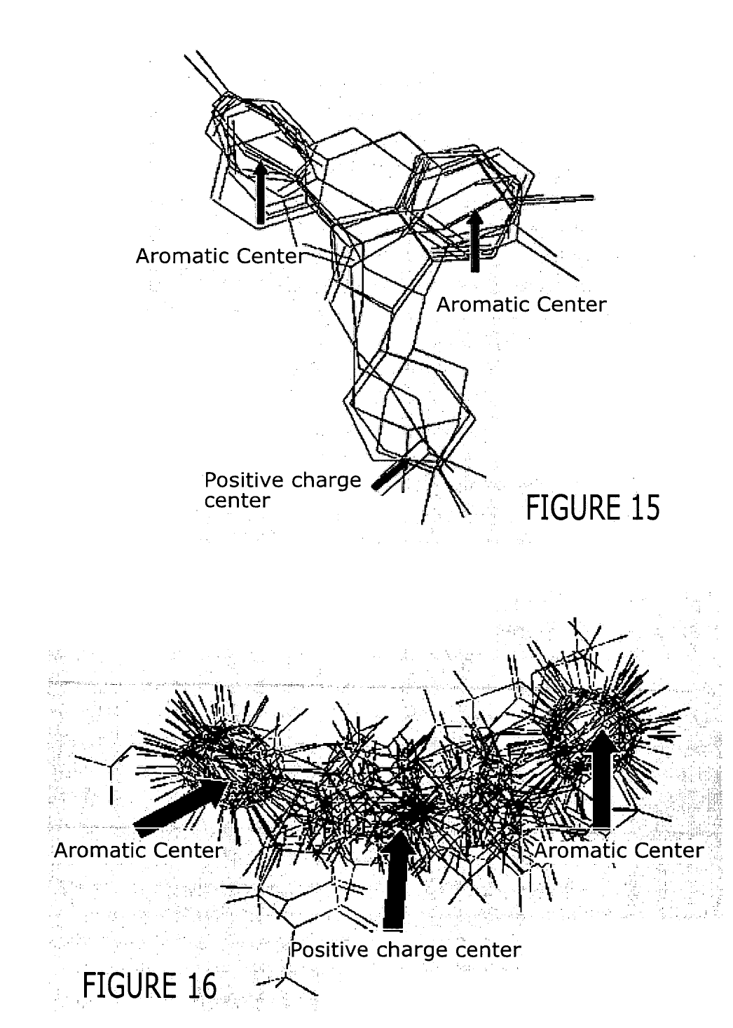

Example 3. A 3D study of D2 and D4 ligands, as described in the above-cited Bostrom et al. publication, reports 3D pharmacophores for D2 and D4 activity. Six of the compounds that were relatively selective for D2 compounds were submitted, together with six of the compounds that were relatively selective for D4. Both types of compounds were submitted together to mimic a situation that might be expected to happen in practice where the experimenter is unaware that there are two binding modes or locations. Embodiments of the invention reproduced the pharmacophores for both D2 and D4. See FIGS. 15 and 16. As may be expected, when the compounds were submitted to embodiments of the invention separately, the same two pharmacophores were obtained. This data set was chosen to demonstrate that embodiments of the invention can find multiple pharmacophores within a single data set. The above-cited Van Drie publication states, “ . . . it is inherent in the pharmacophore discovery problem that most data sets are consistent with multiple pharmacophores.” There are two distinct situations. The data set can be ambiguous. There are multiple mathematical solutions, yet there is thought to be only one binding mode and binding site. Alternatively, there can be two or more binding modes or binding sites. It is generally believed that if the data set contains molecules that bind in two or more different ways that the problem will be difficult to solve with existing analysis strategies. Embodiments of the invention appear to be able to deal with the multiple binding mode situations. This example was chosen to be representative of a potentially difficult problem.

Additional discussion will now be provided. One way to think about the pharmacophore identification problem is to consider the most potent and rigid molecule and determine if other molecules and their features can be mapped onto this pharmacophore prototypical molecule. It can be a very big intellectual and computational leap to consider all the molecules. Even pair-wise comparisons among N molecules generally increase at a rate proportional to N². Moreover, each molecule will typically have many energetically feasible conformations. The full-scale problem, the comparison of each conformation of one compound to all the conformations of all the other compounds, may be essentially computationally hopeless. For example, 500 conformations each of 100 molecules may lead to extremely large numbers of possibilities. Some embodiments of the invention, however, can create a model of the active conformation and its key features, the Q vector and A matrix. The information about this model is captured in the Q vector that gives the probability that a feature is important and the A matrix giving the probabilities that a conformation is the binding conformation. Given the model of the active conformation and its key features, each conformation for each molecule under consideration can be compared to the model. What would have been a many to many comparison, now can become a many to one comparison, according to some embodiments of the invention.

It appears somewhat remarkable that some embodiments of the invention can start with essentially nothing (neither the active conformation for each molecule nor the key features are known) and that some embodiments of the invention can converge to a good answer. Statistical theory may imply that embodiments of the invention will converge, but appears silent on the rate at which embodiments of the invention will converge. Embodiments of the invention appear to work on the above examples and may be expected to work on data sets where the data is consistent with a solution. A potential justification on why embodiments of the invention should work is as follows. Start with a randomly chosen conformation for each active molecule. Search these conformations for features that are in common. Once a few features that are in common (and presumed to be important) are found, embodiments of the invention can judge better which conformations are likely to be binding. Given better conformations, embodiments of the invention are then better able to point to binding features. In practice, in the examples studied, the process appears to converge rapidly to a solution.

A data set can be trivial. Suppose that the data set contains a very active, rigid molecule. If there is a rigid compound then an active analog method may be used, as described, for example, in Marshall et al., “The Conformational Parameter In Drug Design”, in Computer-Assisted Drug Design, Olsen, E. C. Christoffersen, R. E. Eds., American Chemical Society, Washington, D. C. Vol. 122, pp. 205-226, 1979. A data set may allow multiple solutions; the data set may not be definitive. Suppose that close analogs are being examined. If all the molecules have essentially the same fragments on opposite sides of a rotatable bond, then the data set is consistent with a range of solutions. Some judgment may be used in selecting a set of molecules for analysis. Judgment also may be used in the examination of the solution. Embodiments of the invention can provide a very rapid computer-aided search for a consistent solution to a very complex 3D search and matching problem. Days or weeks of analysis can be performed in minutes to a few hours, in some embodiments.

Gibbs sampling according to some embodiments of the invention can be used for more complex situations. For example, the multiple binding mode can be mimicked by applying embodiments of the invention to a data set with two sets of active compounds, D2 and D4, where each set has a different pharmacophore. Several examples were run by mixing compounds active against two different targets, as described in Xue et al., J. Chem. Inf Comput. Sci., 40, pp. 1227-1234, 2000. As was shown above, embodiments of the invention could find elements of the correct pharmacophore when the sets are analyzed separately and, again, somewhat remarkably, it can find the two pharmacophores when the two data sets are analyzed together as one data set. Of course, there is no guarantee that embodiments of the invention will always find multiple binding modes.

One potential weakness in conventional pharmacophore identification programs is the potential limitation in the number of conformations that can be used in the search process. Catalyst® appears limited to 255 conformations for each molecule. DISCO® appears to be limited to 80 conformations. Embodiments of the invention can consider only one conformation for each molecule while it is making a determination of the key features, but once it has tentative key features it can rapidly examine a large number of conformations for each molecule. Embodiments of the invention can replace a many-to-many comparison with many-to-one comparisons. For each of N molecules, compare the “model” active conformation to each of the conformations for each of the compounds under consideration. The calculations are order n rather than

$$( \begin{matrix}n \\ 2\end{matrix} ) , where n = {\sum }_{i = 1}^{N} {M}_{i} ,$$

the total number of conformations. It will be understood, however, that some embodiments of the invention may not check all possibilities so there is no guarantee that the process will find the optimal solution. Moreover, some embodiments of the invention may assume that there is a single binding mode (or just a few) and a consistent set of key features for the binding mode (or key features for each of the few binding modes).

A data set might allow multiple consistent solutions, so embodiments of the invention may be started multiple times and the output examined to see that if the solutions are consistent. As embodiments of the invention can be very fast, it is possible to do rigorous hold-out cross validation, as described, for example, in Burman, Biometrika, 76, pp. 503-514, 1988.

As was described in FIG. 2, Block 430, and FIG. 8, embodiments of the invention can be extended to the regression situation. Suppose that a continuous measure of biological activity, y (270) also is available. Again consider feature-distance-feature triples. These can be used to make a bit string for each conformation. Again, the conformations can be placed end to end to build a vector of descriptors for each molecule. Embodiments of the invention can start by selecting at random a single conformation for each of the molecules. Again, one molecule is left out as it is desired to make predictions on which of its conformations is likely to be an active conformation. Given the y and X (the inferred conformations 250), a model can be built using any of a number of regression-like predictions (multiple linear regression, PLS, ridge regression, etc.) Using this tentative regression model, a prediction can be made as to the likelihood of each of the conformations of the molecule that was left out of the process of being the active conformation. Again, each molecule is left out in turn. Once the process converges, a prediction of the active conformation for each molecule as well as a regression model that relates the features of the molecules to the biological activity is obtained. This strategy can operate on data sets similar to the Catalyst® HypoGen module. Again, in this situation, some embodiments of the invention may have essentially no potential limitation on the number of conformations that can be considered. Again, there may be data set limitations. A data set might allow multiple consistent solutions, so embodiments of the invention may be started multiple times and the output examined to see that the solutions are consistent. As embodiments of the invention can be very fast, it is possible to do rigorous hold-out cross validation.

More benchmarking may be performed to understand the range of data sets that can be successfully analyzed according to some embodiments of the invention. The computational speed can be good so larger numbers of compounds and/or larger numbers of conformations can be used. For the time being, some of the conventional dataset advice for Catalyst can be considered a guide. For example, there should be multiple, diverse compounds that appear to follow only one (or in the case of some embodiments of the invention, a few binding) mechanism. Having compounds that are fairly rigid may help. Predictors that capture potentially important information about the activity of the compounds are desirable. The compounds and their conformations can be structurally diverse.

In some embodiments of the invention, the post processing can look for and cater to multiple binding modes. Alternatively, after the execution of some embodiments of the invention, the identified key features may be used to cluster the compounds. If there are distinct clusters, then embodiments of the invention can be executed on compounds from each cluster on the reasonable assumption that these compounds from the different clusters might be binding in different ways. Note that once the key features are identified from the first run, the clustering may be more likely to correctly identify compounds binding in different ways.

Embodiments of the invention can offer a number of potential advantages for pharmacophore identification. The large datasets that can be considered at high speed because searches can be many to one. In effect, the Q vector contains the information on the key features and the features of each selected conformation are compared to it. The A matrix holds the information on the likelihood that a conformation is the binding conformation and each conformation within a molecule can be compared to A. Embodiments of the invention need not try to compare each conformation of one molecule against all the conformations of another. Relatively large data sets can be used. For example, for the 78 ACE compounds there were 46,268 conformations. The problem was run in 34 hours on a desktop Windows machine. A small data set of six compounds and 6,995 conformations was run in 36 minutes.

In the drawings and specification, there have been disclosed embodiments of the invention and, although specific terms are employed, they are used in a generic and descriptive sense only and not for purposes of limitation, the scope of the invention being set forth in the following claims.

1. A method of identifying pharmacophores in a plurality of molecules comprising:
(1a) generating a set of conformations for a respective molecule, a respective conformation comprising a series of features that are present or absent in the conformation, a respective feature comprising at least two molecular elements and at least one distance therebetween; and
(1b) repeatedly comparing the features for a set of conformations for a given molecule, to a model of feature importance of remaining molecules, to identify an inferred conformation for the given molecule and update the model of feature importance, until the model of feature importance converges.

2. A method according to claim 1 wherein the repeatedly comparing (1b) comprises:
(2a) selecting an initial inferred conformation for a respective molecule from the set of conformations for the respective molecule, to generate an initial set of inferred conformations for the plurality of molecules;
(2b) for a given molecule, identifying features that are present in the inferred conformations for the remaining molecules to obtain an initial model of feature importance;
(2c) comparing the set of conformations for the given molecule to the initial model of feature importance to identify an updated inferred conformation for the given molecule;
(2d) replacing the initial inferred conformation for the given molecule with the updated inferred conformation for the given molecule;
(2e) repeating the identifying of the features (2b), the comparing of the set of conformations (2c) and the replacing of the initial inferred conformation (2d) for the remaining molecules to obtain an updated model of feature importance and a set of updated inferred conformations for the plurality of molecules; and
(2f) repeatedly performing the identifying of the features (2b), the comparing of the set of conformations (2c), the replacing of the inferred conformation (2d) and the repeating (2e), until the updated model of feature importance for the plurality of molecules converges to thereby obtain a final model of feature importance.

3. A method according to claim 2 wherein the identifying of features (2b) comprises:
(3a) identifying features that are present in the inferred conformations for the remaining molecules to obtain a model of feature prevalence;
(3b) comparing the model of feature prevalence with a model of historical prevalence for the features to obtain the model of feature importance; and
(3c) comparing the conformations for the given molecule with the model of feature importance to obtain a model of conformation likelihood for the respective conformations of the given molecule.

4. A method according to claim 1 wherein the repeatedly comparing (1b) is performed using Gibbs sampling, expectation maximization and/or stochastic sampling.

5. A method according to claim 1 further comprising:
(5a) repeatedly mapping the model of feature importance onto the respective inferred conformations to obtain one or more pharmacophore hypothesis sets of features for a respective conformation;
(5b) identifying inferred conformations that are consistent with the respective hypothesis sets of features; and
(5c) selecting one or more of the pharmacophore hypothesis sets based upon a measure of conformations that are consistent with the respective pharmacophore hypothesis sets.

6. A method according to claim 5 wherein the repeatedly mapping (5a) comprises:
(6a) identifying one or more completely connected graphs that are consistent with the respective hypothesis sets of features that were inferred.

7. A method according to claim 6 wherein the identifying of one or more completely connected graphs (6a) comprises executing a clique finding algorithm.

8. A method according to claim 6 wherein the identifying of one or more completely connected graphs (6a) comprises executing a Bron-Kerbosch algorithm.

9. A method according to claim 1 further comprising:
(9a) identifying two or more pharmacophores that are consistent with the inferred conformations that have converged.

10. A method according to claim 2 wherein the comparing of the set of conformations for the given molecule to the initial model of feature importance (2c) comprises:
(10a) using regression to compare the set of conformations for the given molecule to the initial model of feature importance, taking into account relative potency data for the plurality of molecules, to identify an updated inferred conformation for the given molecule.

11. A method according to claim 10 wherein the regression (10a) is performed using multiple linear regression, partial least squares, ridge regression, neural network, logistic regression and/or support vector machine techniques.

12. A computer program product that is configured to execute the method of claim 1.

13. A system that is configured to perform the method of claim 1.

14. A method of identifying pharmacophores in a plurality of molecules comprising:
(14a) generating a set of conformations for a respective molecule, a respective conformation comprising a series of features that are present or absent in the conformation, a respective feature comprising at least two molecular elements and at least one distance therebetween; and
(14b) identifying two or more pharmacophores that are consistent with the set of conformations.

15. A method according to claim 14 wherein the identifying of two or more pharmacophores that are consistent with the set of conformations (14b) comprises:
(15a) identifying two or more completely connected graphs that are consistent with the set of conformations.

16. A method according to claim 15 wherein the identifying of two or more completely connected graphs that are consistent with the set of conformations (15a) comprises executing a clique finding algorithm.

17. A method according to claim 15 wherein the identifying of two or more completely connected graphs that are consistent with the set of conformations (15a) comprises executing a Bron-Kerbosch algorithm.

18. A computer program product that is configured to execute the method of claim 14.

19. A system that is configured to perform the method of claim 14.

20. A method of identifying pharmacophores in a plurality of molecules comprising:
(20a) generating a set of conformations for a respective molecule, a respective conformation comprising a series of features that are present or absent in the conformation, a respective feature comprising at least two molecular elements and at least one distance therebetween; and
(20b) using regression to compare the set of conformations for the respective molecules to a model of feature importance, taking into account relative potency data for the plurality of molecules, to identify inferred conformations for the plurality of molecules.

21. A method according to claim 20 wherein the regression (20b) is performed using multiple linear regression, partial least squares, ridge regression, neural network, logistic regression and/or support vector machine techniques.

22. A computer program product that is configured to execute the method of claim 20.

23. A system that is configured to perform the method of claim 20.
